(19) United States
(12) Patent Application Publication
(10) Pub. No.: US 2024/0053745 A1
(43) Pub. Date: Feb. 15, 2024

(54) Extended Reality helmet

(71) Applicant: Reby Inc., Walnut, CA (US)

(72) Inventors: Akash Kadechkar, Barcelona (ES); Elisabet Bayo Puxan, Barcelona (ES); Julio Gonzalez Lopez, Igualada (ES); Xiaolei Song, Barcelona (ES); Richard Comas Xanco, Tordera (ES); Eugeni Llagostera Saltor, Barcelona (ES)

(21) Appl. No.: 17/819,315

(22) Filed: Aug. 12, 2022

(51) Int. Cl. G05D 1/00; G06F 1/16; G05D 1/02; A42B 3/30

(52) U.S. Cl. CPC G05D 1/0038; G06F 1/163; G05D 1/021; G05D 1/0016; A42B 3/30

(57) ABSTRACT

An XR helmet collects user data and environmental data using onboard sensors. The collected data is used to train a model for predicting safe rides in a rental fleet of lightweight vehicles. The XR helmet is configured to selectively take control of the lightweight vehicle when driver biofeedback or environmental data are predictive of unsafe driving conditions. Access and control of fleet vehicles is controlled by a predictive machine learning model trained by data indicative of safe and unsafe driving conditions.

### FIELD OF THE INVENTION

The present disclosure generally relates to helmet-based driver-safety systems for rental fleets of small vehicles, such as electric scooters.

### BACKGROUND OF THE INVENTION

Accidents caused by driver errors are a known public health and safety issue. Such accidents are especially dangerous for two and three wheeled vehicles because the vehicles themselves are relatively lightweight and do offer much protection to the driver in case of accidents. Many solutions and strict laws have been implemented to prevent vehicle accidents, but the number of accidents caused by driver error are still a significant public-safety problem.

Moreover, with the increasing popularity of shared mobility and delivery services, the incidents of driving accidents involving shared vehicles is expected to increase. Along with environmental dangers, driver error plays a large part in accidents. Driver error comprises inattention, negligence, drivers under the influence of alcohol and drugs and impairment due to fatigue, drowsiness, and so on.

Vehicle rental services and fleet operators have frequent accidents because, in addition to the other safety risks inherent in driving a vehicle, the driver is not necessarily familiar with the rented vehicle as with a personally owned vehicle. Besides damage to the rider and the vehicle, such accidents also result in the loss of fleet productivity, revenue, insurance claims, quality of service, up time, and so on.

There exist products like smart helmets, intelligent helmets, augmented reality helmets, and so on. But these helmets are typically used only for real-time monitoring purposes and not for predictive driver safety. Improved accidents-reduction systems for lightweight fleet-managed vehicles are desirable to help drivers avoid creating safety risks for other drivers and themselves.

### SUMMARY OF THE INVENTION

The XR helmet predicts user trajectory and the user state of mind. For example, in case of bad weather or rain, the XR helmet will reconstruct the real-world environment into a virtual world so that the rain and the bad weather will be eliminated on the XR HUD (Extended Reality Head Up Display) avoiding distraction. At a given time, the XR helmet calculates a safety vector for the driver based on collected real-time data and data stored in a database. The data used for calculating the safety vector comprises driver biofeedback, environmental conditions, and other data with a causal link to driver safety.

The XR HUD is also capable of displaying the real world with the augmentation of additional content like maps, speed, camera views, and alerts. In some embodiments, the additional content includes virtual elements, such as coins or markers. In an embodiment, this content is displayed on demand by the driver using commands, including voice activation.

The XR helmet is designed for use with lightweight vehicles, which comprise personal mobility vehicles, such as electric scooters, Segway, hoverboards, unicycles, and some e-bikes. For lightweight vehicles with a separate passenger seat, an XR helmet for the passenger may be provided. The passenger's XR helmet allows the rider the option to use the XR helmet as an entertainment device for watching content, communicating with the primary rider, or watching the same screen as that seen by the driver.

The XR helmet can share the screen of the rider not only to the secondary seater but also to any other person or entity. For example, the screen sharing can be used for remote guidance to the rider. Any person from their home can guide or even ride the actual vehicle remotely. This feature can even be extended to gamers. The gamers from their home using XR helmets can ride an actual vehicle.

XR helmet reconstructs the real-world into a virtual world or mixed reality on demand and the user will immerse in a gaming experience or a metaverse. The XR helmet collects biofeedback samples from the driver from a variety of sensors. These biofeedback samples, along with other environmental data, are used to calculate a safety vector for the lightweight vehicle. The safety vector may be recalculated in real time or at predetermined intervals.

Using the combination of the different sensors, the XR helmet estimates the current and future state of mind of the rider and the vehicle trajectory. These estimates, also referred to as a safety vector, are used to protect the driver of the lightweight vehicle. For example, if the predicted future actions suggest a dangerous condition, then the XR helmet sends information to the vehicle to prevent such actions by alerting or warning to the user or switching the vehicle to semi-autonomous mode. For safety or other reasons, the XR helmet may be required for use with the lightweight vehicle. In some embodiments, the XR helmet chin strap is automatically released after the ride is finished.

In an embodiment, the XR helmet assists a driver of a lightweight vehicle and includes a protective enclosure for the driver's head and a transparent visor, a processor configured for edge artificial intelligence (AI). The XR helmet also has a plurality of sensors with real-time driver data collected by way of the plurality of sensors. A machine-learning model is trained to calculate a safety vector from the driver's real-time data. When the machine learning model determines that the driver's safety vector exceeds a predetermined threshold, the XR helmet assumes control of one or more driving parameters.

In an embodiment, collected real-time driver data are not saved locally after the calculation of the safety vector. In a further embodiment, collected real-time driver data comprises one or more of biofeedback data and environmental data. Alternatively, collected biofeedback data includes one or more of driver EEG, heart rate, blood-alcohol concentration, body temperature, and perspiration.

In an embodiment, the XR helmet is part of a system for assuming control of a lightweight vehicle in a shared-vehicle fleet, the system comprising the XR helmet communicatively coupled to one or more sensors for collecting real-time driver data. A machine-learning database is prepared comprising data indicative of safety conditions. A machine-learning model is trained to calculate a safety vector from the collected real-time data. A control mechanism for the lightweight vehicle communicatively coupled to the XR helmet and configured to be activated when the machine learning model determines that the collected real-time data predicts a risk of accident exceeding a predetermined threshold. In some embodiments, the machine learning model accesses a database of driver data not collected from the potential driver. In other embodiments, the XR helmet is communicatively coupled to a cloud server. In some of these embodiments, the cloud server comprises a machine-learning database. For example, the cloud server further comprises first and second machine-learning databases. In some embodiments, the first database comprises third-party biofeedback data and the second database comprises third-party environmental data. In an embodiment, the first and second machine-learning databases comprise historical biofeedback or environmental data collected by XR helmets used by riders of shared-fleet vehicles. In these and other embodiments, the machine learning model is updated using the collected historical data.

A method for controlling a lightweight vehicle by way of an XR helmet worn by a driver within a shared-vehicle fleet is also disclosed. The method comprises collecting real-time data from the driver vehicle by way of the XR helmet. With the machine learning model, a safety vector is calculated corresponding to a probability that the collected biofeedback suggests unsafe conditions for the driver. Access to the lightweight vehicle is restricted by way of a control mechanism when the probability of unsafe conditions exceeds a predetermined threshold. In an embodiment, the real-time data is collected by way of electrodes in the XR helmet. In some embodiments, the real-time data is collected by way of a gas sensor in the XR helmet. In alternative embodiments, the machine learning model is created from a database of driver data not collected from the potential driver. Alternatively, the machine learning model is created from a database of driver data that includes the potential driver. In some embodiments, the machine learning model is updated using data collected from XR helmets used in connection with lightweight vehicles in the shared-vehicle fleet. In alternative embodiments, the machine learning model is updated with historical driver data collected by XR helmets used by drivers of fleet vehicles. In some embodiments, the machine learning model is updated for the driver by storing data about the driver's rides within the shared-vehicle fleet.

### DESCRIPTION OF THE DRAWINGS

FIG. 1 shows an embodiment of an XR helmet according to the invention.

FIG. 2 shows an overview of the lightweight vehicle ecosystem comprising an XR helmet, a lightweight vehicle, a smartphone, and a backend cloud server.

FIG. 3A shows an embodiment where the lightweight vehicle is controlled by a an XR helmet by way of a backend server.

FIG. 3B shows an embodiment where the lightweight vehicle is controlled by an XR helmet in communication with a backend server.

FIG. 4 shows a machine-learning algorithm for reaching a conclusion about the safety vector of a lightweight vehicle based on driver biofeedback samples.

FIG. 5 shows a machine-learning algorithm for reaching a conclusion about the safety vector of a lightweight vehicle based on environmental data.

FIG. 6 shows an embodiment of the interaction between a backend cloud server and an XR helmet that collects user biofeedback samples.

FIG. 7 shows an embodiment wherein the XR helmet uses an edge artificial intelligence (AI) workflow.

### DETAILED DESCRIPTION

There are different causes of accidents. One category of causes stem from the state of mind of the rider, such as impairment due to alcohol, drugs, fatigue, drowsiness, and so on. Another category of causes stem from external conditions like rain, dust, wind, sunlight glare, and so on. Further examples of external causes include dangerous road conditions like potholes, speed breakers, steep slopes, and so on. Or the lightweight vehicle itself can be dangerous because of poor maintenance. Yet another category comprises rider distractions such as notifications from smartphones or other electronic devices, environmental distractions like lights and sounds, movement and sounds from other vehicles, and so on.

Generally speaking, accidents can be prevented if accident-causing parameters such as those listed above can be predicted or forecasted. The invention provides a reliable solution for preventing accidents by measuring a variety of parameters in real-time. These parameters include the rider's state of mind, weather condition, road conditions, and vehicle condition using a set of sensors embedded in the helmet. These real-time measurements are used for forecasting the accidents in advance using AI algorithms to calculate a safety vector that correlates to the need to take preventive measures by way of overriding manual controls. These preventive measures are taken depending on the nature of the threat and in accordance with the calculated safety vector. At the same time, inconvenience and distractions are avoided so the rider has an immersive and safer driving experience. To achieve an immersive, but safe driving experience, sensors embedded in the helmet monitor and control a variety of conditions, such as the temperature and airflow inside the helmet. Voice guided navigation and assistance is also provided where useful. Moreover, the embedded electronics in the helmet are powered by different energy harvesting sources like solar, thermal, wind and piezoelectric. In an embodiment, battery power is also used as either an alternative to self-generated power or the sole source of power for one or more XR helmet components.

The XR helmet employs hardware such as a VPU (Vision Processing Unit), for example the Intel Neural Computing Stick 2 (NCS 2) based on the Intel Movidius Myriad X. The Myriad X VPU features a Neural Computer Engine for deep neural network inference and is programmable with the Intel distribution Open VINO Toolkit. Alternatively, the XR helmet employs a GPU (Graphics Processing Unit), such as the NVIDIA Jetson Nano. This development board runs neural networks using the NVIDIA Jetpack SDK and offers non-optimized Keras and TensorFlow libraries. Alternatively, the XR Helmet uses a TPU (Tensor Processing Unit), AI hardware that implements all control and logic for machine learning algorithms. An example is Google's Coral Edge TPU, which includes a toolkit for local AI production including on-device AI applications that require low power consumption and offline workflows. Google Coral implementations enable machine learning frameworks such as TensorFlow Lite, YOLO, and R-CNN for object detection and object tracking.

In an embodiment, the helmet's visor acts as a display, for example, by way of a smart glass insert. In a further embodiment, the visor adapts to weather conditions such as fog or glare or low light by, for example, altering the brightness in response to these external conditions. In some embodiments, the helmet switches the rider's view to virtual reality when external conditions make the rider's unassisted vision unreliable or dangerous.

In various embodiments, the helmet includes one or more sensors such as a camera, accelerometer, gyroscope, wireless connectivity adapter, microphone, audio speaker, gas sensor, touch sensor, and so on. In an embodiment, the helmet is self-powered using solar panels. The sensor is configured for collecting real-time data about the driver. This data includes biofeedback of the user and environmental data about the driver's surroundings and road conditions.

In an alternative embodiment, non-driver riders wearing the XR helmet can switch to auto-pilot mode and watch videos during the trip.

In yet another embodiment, a superuser such as an administrator remotely takes control of the smart helmet and thereby controls the lightweight vehicle when required by security or safety conditions.

In some embodiments, the helmet offers voice assistance to take input or instructions from the driver. The driver's instructions are carried out in whole or in part depending on safety conditions. In some embodiments, improvements in driver experience are achieved by noise cancellation features. Noise cancellation may be switched off depending on environmental conditions. For example, in some embodiments, noise cancellation is turned off when emergency vehicles are nearby based on either auditory cues, such as sirens, or visual cues, such as flashing lights.

In an embodiment, driver condition is monitored by EEG electrodes that monitor brain activities. In an alternative embodiment, the helmet is equipped with smart gas sensors to detect gas inhaled or exhaled by the driver. In an embodiment, helmet-based sensors measure exhaled breath alcohol concentration or Co2 level. In a further embodiment, inhaled oxygen or organic gasses are measured. In a further embodiment, the helmet includes a driving-facing camera to record images of the driver's face, eyes, or a combination of features.

In alternative embodiments, the helmet includes IMU (inertial measurement unit) sensors or sensors to detect driver body temperature, heart rate, external temperature, and so on. Alternatively, data collected by a driver's mobile device, linked to the helmet, can be used alongside or instead of data collected by sensors installed on the helmet.

Based on the past driving history of the driver and other drivers, a safety vector is calculated to allow for prediction of unsafe conditions likely to lead to accidents.

The system generally comprises an XR helmet, mobile device, a backend cloud server, and shared lightweight vehicles under fleet-management control. The lightweight vehicle is typically a two-wheeled scooter, either powered or unpowered. The vehicle is ridden by its driver and possibly other passengers. Other lightweight vehicle configurations are also possible, with one, three, or four wheels, for example.

Enhanced safety is provided by way of an XR helmet managed in part by a shared mobility and fleet management entity. In a typical embodiment, a prospective lightweight vehicle driver has a history of biofeedback data collected from previous trips. In an embodiment, the biofeedback data includes data collected during registration as a user of vehicles in the shared fleet. The biofeedback data includes brain waves, which can be monitored by scalp sensors using an electroencephalograph (EEG). The biofeedback data also includes rider heart rate, which can be monitored, for example, by earlobe sensors with a device used to detect blood volume changes (photoplethysmograph). Other biofeedback data includes body temperature, perspiration, and so on.

The biofeedback data is processed by a mobile device application using a machine learning model trained to calculate a safety vector for the lightweight vehicle. Examples of a calculated safety vector include increased risk of accidents due to poor weather conditions, driver impairment, or external driver distractions such as electronic device notifications or unusual movements or sounds from other vehicles or pedestrians.

The biofeedback samples collected during vehicle operation are sent to the backend server for calculating future safety vectors and fine tuning the machine-learning model. In a typical embodiment, a safety vector that identifies the driver as impaired limits the driver's access to the vehicle and the backend server will save the collected biofeedback data. In some embodiments, the biofeedback sample is marked as an impaired sample for future use in training the machine learning model. In an embodiment, a mobile device application or the XR helmet gives the driver a notification with the results of the machine learning algorithm. In some embodiments, the XR helmet or the vehicle notifies the user through a display indication or sound, or both. The type of notification may also depend on local laws and regulations.

The system includes a cloud-computing component. A machine learning model is trained to detect unsafe conditions by way of calculating a safety vector. A second component comprises an edge computing deployment of the model in the XR helmet or a driver-associated smartphone app for real-time detection.

A machine learning model is created for calculating safety vectors. In an embodiment, biofeedback data associated with unsafe drivers are collected, for example, from online and public sources. The data can also be collected in whole or in part from XR helmet users. Alternatively, environmental data is also collected.

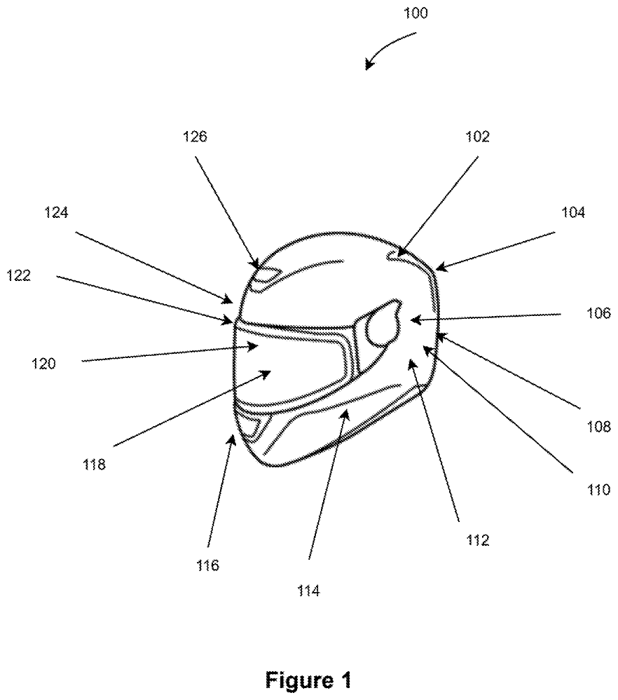

FIG. 1 shows XR helmet 100 and its components in an exemplary embodiment. In this embodiment, the XR helmet is equipped with a plurality of real-time sensors. For example, EEG signals from the electrodes integrated in the helmet to monitor brain activity. A front camera and rear camera capture the surroundings, environmental conditions, and drive path trajectory. An infrared camera integrated inside the helmet to capture the face reactions. A gas sensor is positioned near the mouth to monitor the air inhaled, and the air exhaled by the driver. This sensor is used to monitor environmental conditions affecting the user such as pollution inhaled by the driver. This sensor is also used to measure driver biofeedback data such as BAC, CO2 levels, and so on.

Other features of XR helmet 100 include a transparent Organic Light Emitting Diode (OLED), a Heads-Up Display (HUD) as a Visor to display augmented reality views. Examples of such views include reality, vehicle parameters, navigation, and camera views. In an embodiment, XR helmet 100 includes a display for virtual reality, comprising a 3D model of the rider's environment. In alternative embodiments, virtual parameters like coins are added. In other embodiments, XR helmet 100 is configured to display mixed reality views combining reality and augmented reality and virtual reality.

Some embodiments of XR helmet 100 include other features such as an external speaker for guided navigation, music, warning, mobile calling, and so on. Alternatively, or in combination with these features, XR helmet 100 includes a vibration motor for notifications.

In an embodiment, XR helmet 100 includes heating and cooling elements to improve driver comfort and remove distractions associated with extreme temperatures.

In an embodiment, XR helmet 100 communicates wirelessly by BLE/5G with the lightweight vehicle and by 4G/5G with backend cloud services that manage the shared fleet.

For example, in an embodiment XR helmet 100 is configured with a plurality of sensors and features. The upper surface of XR helmet 100 includes solar cell 102 for power generation. A rear-facing camera 104 is configured to record environmental conditions and give the driver the ability to see objects not otherwise in the driver's field of vision.

Other features include temperature controller 106, gas sensor 116, smart visor 118, HUD 120, front camera 122, IMU sensor 124, and electrodes 128.

In an embodiment, XR helmet 100 is fitted with a chinstrap containing a piezoelectric or other sensor for collection of user data. In some embodiments, the interior of the helmet is fitted with an airflow controller, such as a fan.

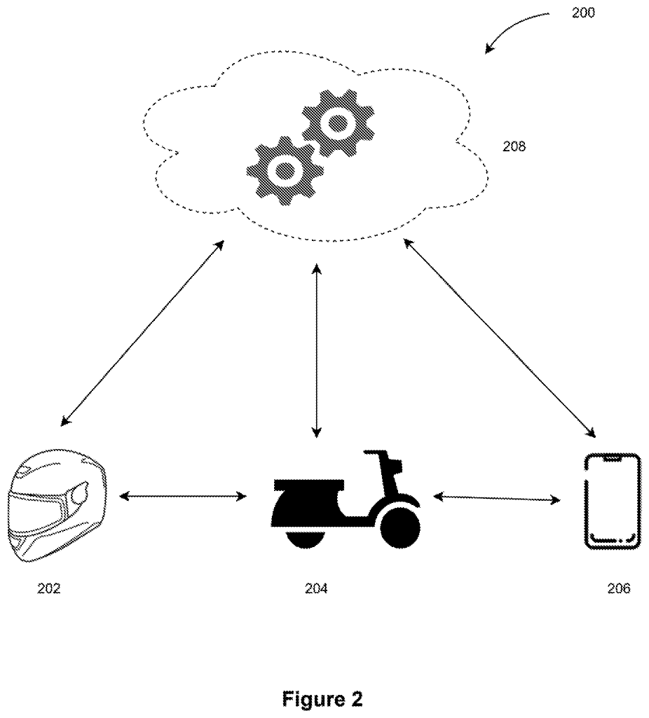

FIG. 2 shows an overview 200 of a cloud-based system incorporating XR helmet 202, the lightweight vehicle's electronic system 204, and the driver's mobile device 206. XR helmet 202, lightweight vehicle electronic system 204, and mobile device 206 are all in two-way communication with cloud services 208. Further, XR helmet 202 communicates with lightweight vehicle electronic system 204. Mobile device 206 also communicates with vehicle electronic system 204. Vehicle electronic system 204 is in two-way communication with XR helmet 202, mobile device 206, and cloud services 208.

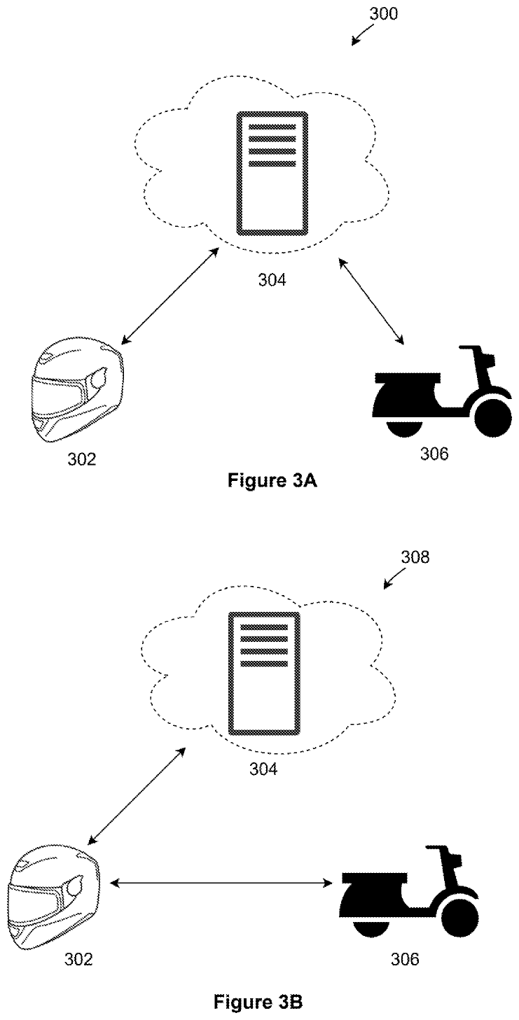

FIG. 3A shows elements of system 300 and their relationship to each other. XR helmet 302 communicates with lightweight vehicle 306 by way of cloud server 304. FIG. 3B shows an alternative embodiment where XR helmet 302 communicates directly with cloud server 304 and with lightweight vehicle 306 by, for example, a Bluetooth connection.

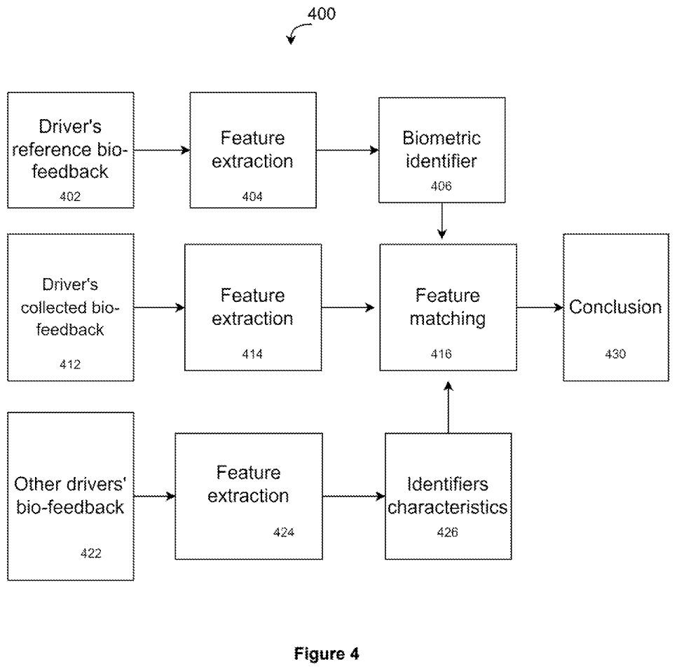

FIG. 4 shows an exemplary embodiment of a first machine learning model 400. In an embodiment, a prospective driver of lightweight vehicles in a shared fleet provides uniquely identifiable information upon enrollment. In an embodiment, the information comprises an image of the driver's face. In alternative embodiment, the information comprises an audio sample of the driver's voice. Other driver-specific information could also be used, including partial images of the driver's face or other identifiable characteristics of the driver. In an embodiment, the information includes driver data such as EEG data, heart rate, body temperature, and perspiration levels.

At step 402, a driver's initial or historical biofeedback is collected. This biofeedback acts as reference data for calculating a safety vector. The collection of biofeedback 402 is accomplished by the XR helmet or provided independently by the driver or a third party. In an embodiment, the rider's first accident-free trip using the XR helmet supplies reference data for calculating a safety vector.

At step 404, feature extraction is performed. A feature is an input variable used in making predictions. One feature is typically a class label that defines the class this instance belongs to. Feature extraction reduces the number of features in a dataset by creating new features from the existing ones. The original features may then be discarded.

At step 406, biometric identifiers of the driver's biofeedback are collected as a result of feature extraction. These biometric features will be used later for feature matching with new driver biofeedback collected by the XR helmet.

At step 412, a driver's video image or audio sample is collected by the mobile device. This collection is done locally by the mobile device. In an embodiment, the collected image or audio sample is timestamped for verification that it reflects the driver's current state. In an embodiment, video images include real-time road conditions from either or both of a front and rear facing camera.

At step 414, the collected driver data undergoes feature extraction to identify face images, environmental images, audio samples, and so on. This collected data will be used at step 416 for feature matching.

At step 422, biofeedback samples are collected in a database of other drivers of lightweight vehicles. In an embodiment, these samples are collected by way of XR helmets from drivers of lightweight vehicles who were involved in accidents. In an alternative embodiment, all personally identifiable information is removed or obscured in the collected samples.

At step 424, feature extraction is performed on the collected images or samples. The set of features extracted are saved as identifiers and characteristics at step 426.

At step 430, a conclusion is reached by using the collected driver biofeedback to train the machine learning model. In an embodiment, conclusion 430 depends on comparing the features extracted from the driver in steps 412, 414, and 416 with both the biofeedback from step 406 and the identifiers and characteristics from step 426. In an alternative embodiment, biometric identifiers from step 406 are not used and the identifiers and characteristics from step 426 are used to reach conclusion 430.

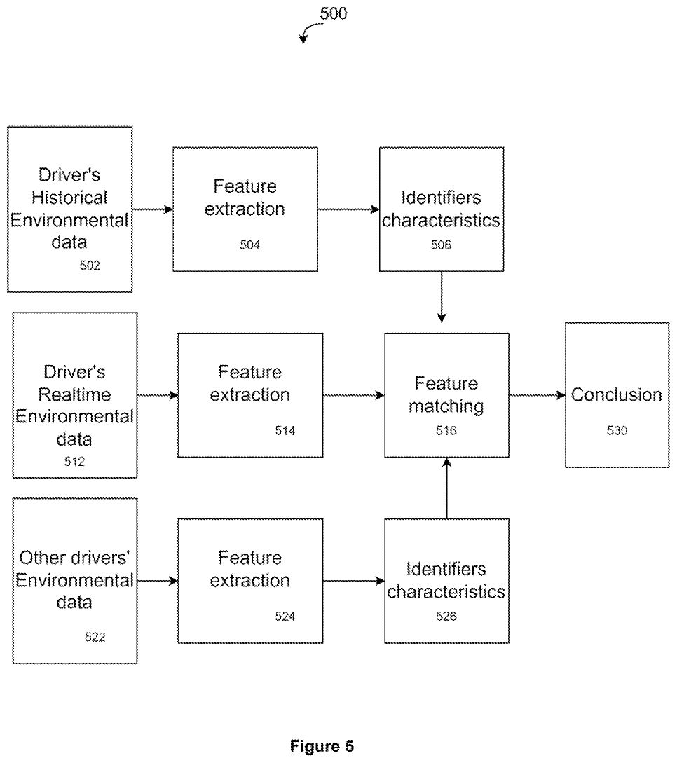

FIG. 5 shows an exemplary embodiment of a second machine learning model 500. This machine learning model can be used independently from model 400, or in combination with it. In an embodiment, environmental data from lightweight vehicles is collected and correlated with accidents and safe trips. In a further embodiment, the environmental data comprises weather information such as temperature, precipitation, and road conditions. In an alternative embodiment, the information comprises data about other external conditions or distractions such as device notifications, emergency vehicles, and the like.

At step 502, a driver's historical environmental data is collected. This data is collected in whole or in part by the XR helmet. Alternatively, peripheral devices, such as a user smartphone, are used for data collection. In some of these embodiments, the peripheral device is linked to the XR helmet either wirelessly or with a wired connection or as an attachment.

At step 504, feature extraction is performed. A feature is an input variable used in making predictions. One feature is typically a class label that defines the class this instance belongs to. Feature extraction reduces the number of features in a dataset by creating new features from the existing ones. The original features may then be discarded.

At step 506, identifiers from environmental data collected as a result of feature extraction. These features will be used later for feature matching with real-time environmental data from the XR helmet.

At step 512, real-time environmental data is collected by XR helmet. This collection is done locally by the XR helmet in whole or in part.

At step 514, the collected environmental data undergoes feature extraction to identify specific environmental parameters. This collected data will be used at step 516 for feature matching.

At step 522, environmental data from other drivers are collected in a database. In an embodiment, the environmental data is from third-party sources. Alternatively, some or all of the environmental data is collected from other drivers of lightweight vehicles of the managed fleet.

At step 524, feature extraction is performed on the collected environmental data. The set of features extracted are saved as identifiers and characteristics at step 526.

At step 530, a conclusion is reached by using the collected driver images or audio samples as a test for input to the machine learning model. In an embodiment, conclusion 530 depends on comparing the features extracted from the driver in steps 512, 514, and 516 with both the biometric identifiers from step 506 and the identifiers and characteristics from step 526. In an alternative embodiment, biometric identifiers from step 506 are not used and the identifiers and characteristics from step 526 are used to reach conclusion 530.

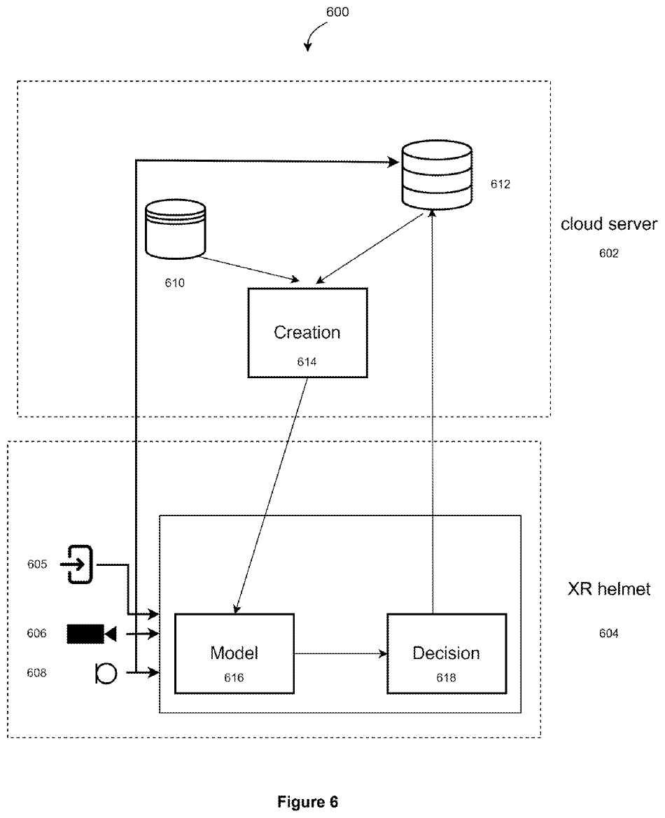

FIG. 6 shows an exemplary system configuration 600 of cloud backend server 602 and XR helmet 604. In this embodiment, cloud server 602 creates a machine learning model that is used by XR helmet for real-time decision making.

In an embodiment, the XR helmet 604 collects biofeedback or environmental data by way of sensor 605. In an embodiment, XR helmet further comprises camera 606 for collecting image data, either driver facing, roadway facing, rearward facing, a combination of these. In an alternative embodiment, XR helmet microphone 608 collects audio samples. In some embodiments, both camera 606 and microphone 608 are provided by XR helmet 604 for collecting driver data. Sensor 607 is an input device that comprises electrodes, breathalyzer, CO2 detector, or similar measurement tools for collecting driver biofeedback data.

In an embodiment, database 610 comprises known biofeedback or environmental data or both. This data is correlated with accidents, or in particular with accidents involving lightweight vehicles. In an embodiment, the database 610 is a repository for biofeedback and environmental data correlated with both accidents and safe trips by lightweight vehicles in the shared fleet. Thus, over time database 610 becomes richer and more finely tuned to the specific parameters found in both accidents and safe trips by lightweight vehicles in the shared fleet.

Database 612 comprises real-time biofeedback or environmental data collected from XR helmet 604. Database 612 and database 610 are used to create a machine learning model 614 by training the model to calculate a safety vector for a driver of a lightweight vehicle. The safety vector is calculated by comparing the features indicative of safety or danger in the reference database 610, 612, or both, with the real-time data being collected by the XR helmet.

Machine learning model 616 receives data from camera 306 or microphone 308, or both. Machine learning model 616 reaches decision 618 as described in connection with FIGS. 4 and 5. The result of the decision is optionally sent to database 612 for optimizing the machine learning model.

When a predetermined safety threshold is reached, XR helmet 604 assumes control of certain aspects of the lightweight vehicle. For example, if the driver's blood-alcohol concentration (BAC) exceeds limits imposed by local law or regulations the lightweight vehicle's starter will be locked out by a command from the XR helmet and the driver will receive a notification that the lightweight vehicle is unavailable for use. Alternatively, if the driver's BAC is below the limit imposed by local law or regulations, the vehicle may still be made unavailable for use if the driver's BAC, either alone or in combination with other biofeedback and environmental data, results in a calculated safety vector that shows a risk of injury above the predetermined safe threshold. In an embodiment, the safety threshold is met when the safety vector indicates a chance of an accident of 10% or higher. The safety threshold is fine-tuned by the system as more driver biofeedback data and environmental data are collected and processed by the machine learning models 400 and 500.

In yet another embodiment, the XR helmet is part of an edge AI workflow. In this embodiment, the XR helmet computes in real time using edge AI. Such edge AI embodiments, in addition to the increased efficiency and reduced latency by bring data and compute closer together, also allow for limiting the kinds and amount of data stored, which may be useful for offering increased privacy to drivers. Such privacy may be desirable to drivers for its own sake, or mainly for compliance with privacy laws and regulations. In alternative embodiments, the XR helmet does not store any data in the cloud, does not store any data locally, or does not store any data in either the cloud or locally.

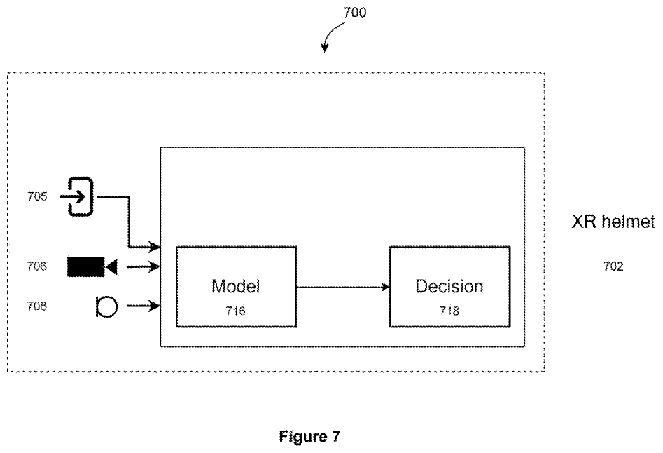

FIG. 7 shows an exemplary system configuration 700 of XR helmet 702. In an embodiment, the XR helmet 702 collects biofeedback or environmental data by way of sensor 705. In an embodiment, XR helmet further comprises camera 706 for collecting image data, either driver facing, roadway facing, or both. In an alternative embodiment, XR helmet microphone 708 collects audio samples. In some embodiments, both camera 706 and microphone 708 are provided by XR helmet 704 for collecting driver data. Sensor 707 is an input device that comprises one or more of electrodes, a breathalyzer, CO2 detector, or similar measurement tool for driver biofeedback.

In an embodiment, database 610 comprises known biofeedback or environmental data or both. This data is correlated with accidents, or in particular with accidents involving lightweight vehicles. In an embodiment, the database 610 is a repository for biofeedback and environmental data correlated with both accidents and safe trips by lightweight vehicles in the shared fleet. Thus, over time database 610 becomes richer and more finely tuned to the specific parameters found in both accidents and safe trips by lightweight vehicles in the shared fleet.

Database 612 comprises real-time biofeedback or environmental data collected from XR helmet 604. Database 612 and database 610 are used to create a machine learning model 614 by training the model to calculate a safety vector for a driver of a lightweight vehicle. The safety vector is calculated by comparing the features indicative of safety or danger in the reference database 610, 612, or both, with the real-time data being collected by the XR helmet.

Machine learning model 716 receives data from camera 706 or microphone 708, or both. Machine learning model 716 reaches decision 18 as described in connection with FIGS. 4 and 5. The result of the decision 718 is optionally saved and used for optimizing the machine learning model.

When a predetermined safety threshold is reached, XR helmet 702 assumes control of certain aspects of the lightweight vehicle. For example, if the driver's blood-alcohol concentration (BAC) exceeds limits imposed by local law or regulations the lightweight vehicle's starter will be locked out and the driver will receive a notification that the lightweight vehicle is unavailable for use. Alternatively, if the driver's BAC is below the limit imposed by local law or regulations, the vehicle may still be made unavailable for use if the driver's BAC, either alone or in combination with other biofeedback and environmental data, results in a calculated safety vector that shows a risk of injury above the predetermined safe threshold. In an embodiment, the safety threshold is met when the safety vector indicates a chance of an accident of 10% or higher. The safety threshold is fine-tuned by the system as more driver biofeedback data and environmental data are collected and processed by the machine learning models 400 and 500. In alternative embodiments, the data used in machine learning models 400 and 500 has personal information about drivers removed. In other embodiments, the edge AI model is trained remotely by a cloud-based backend server or a personal computer and exported to the XR helmet's processing unit. In an embodiment, the edge AI model is periodically updated as new accident data is collected by system XR helmets or acquired from other sources.

1. An extended reality (XR) helmet for assisting a driver of a lightweight vehicle comprising:
a protective enclosure for the driver's head and a transparent visor,
a processor configured for edge artificial intelligence (AI);
a plurality of sensors;
real-time driver data collected by way of the plurality of sensors;
a machine-learning model trained to calculate a safety vector from the driver's real-time data, wherein when the machine learning model determines that the driver's safety vector exceeds a predetermined threshold, the XR helmet assumes control of one or more driving parameters.

2. The XR helmet of claim 1 wherein collected real-time driver data are not saved locally after the calculation of the safety vector.

3. The XR helmet of claim 1 wherein collected real-time driver data comprises one or more of biofeedback data and environmental data.

4. The XR helmet of claim 3 wherein collected biofeedback data includes one or more of driver EEG, heart rate, blood-alcohol concentration, body temperature, and perspiration.

5. A system for assuming control of a lightweight vehicle in a shared-vehicle fleet by way of an XR helmet, the system comprising;
an XR helmet communicatively coupled to one or more sensors for collecting real-time driver data;
a machine-learning database comprising data indicative of a safety condition;
a machine-learning model trained to calculate a safety vector from collected real-time data;
a control mechanism for the lightweight vehicle communicatively coupled to the XR helmet and configured to be activated when the machine learning model determines that the collected real-time data predicts a risk of accident exceeding a predetermined threshold.

6. The system of claim 5 wherein the machine learning model accesses a database of driver data not collected from the potential driver.

7. The system of claim 5 wherein the XR helmet is communicatively coupled to a cloud server.

8. The system of claim 5 wherein the cloud server comprises a machine-learning database.

9. The system of claim 5 wherein the cloud server further comprises first and second machine-learning databases, and wherein the first database comprises third-party biofeedback data and wherein the second database comprises third-party environmental data.

10. The system of claim 9 further wherein first and second machine-learning databases comprise historical biofeedback or environmental data collected by XR helmets used by riders of shared-fleet vehicles, and the machine learning model is updated using the collected historical data.

11. A method for controlling a lightweight vehicle by way of an XR helmet worn by a driver within a shared-vehicle fleet comprising the steps of:
collecting real-time data from the driver vehicle by way of the XR helmet;
calculating, with the machine learning model, a safety vector that correlates to a probability that the collected biofeedback suggests unsafe conditions for the driver;
restricting access to the lightweight vehicle by way of a control mechanism when the probability of unsafe conditions exceeds a predetermined threshold.

12. The method of claim 11 wherein the real-time data is collected by way of electrodes.

13. The method of claim 11 wherein the real-time data is collected by way of a gas sensor.

14. The method of claim 11 wherein the machine learning model is created from a database of driver data not collected from the potential driver.

15. The method of claim 11 wherein the machine learning model is created from a database of driver data that includes the potential driver.

16. The method of claim 11 wherein the machine learning model is updated using data collected from XR helmets used in connection with lightweight vehicles in the shared-vehicle fleet.

17. The method of claim 16 wherein the machine learning model is updated with historical driver data collected by XR helmets used by drivers of fleet vehicles.

18. The method of claim 11 wherein the machine learning model is updated for the driver by storing data about the driver's rides within the shared-vehicle fleet.

19. The method of claim 17 wherein the machine learning model is further updated for the driver by storing data about the driver's rides within the shared-vehicle fleet.

20. The method of claim 16 wherein the data used for updating the machine learning model has no personal identifying information of drivers of fleet vehicles.
